(19) United States
(12) Patent Application Publication
(10) Pub. No.: US 2024/0046220 A1
(43) Pub. Date: Feb. 8, 2024

(54) Customer Experience Interface for Integrated Practice Management Solutions

(71) Applicant: Innovative Veterinary Practices, Lomira, WI (US)

(72) Inventors: Marthina Greer, Lomira, WI (US); Daniel Griffiths, Lomira, WI (US)

(73) Assignee: Innovative Veterinary Practices, Lomira, WI (US)

(21) Appl. No.: 17/882,877

(22) Filed: Aug. 8, 2022

(51) Int. Cl. G06Q 10/10; G06Q 30/02; G06Q 30/04

(52) U.S. Cl. CPC G06Q 10/1095; G06Q 30/0281; G06Q 30/0283; G06Q 30/04

(57) ABSTRACT

A customer experience interface that facilitates provision of veterinary care is described. The customer experience interface may interact with practice resources such as practice management software or systems to generate appointment reminders and provide such reminders to pet owners. The customer experience interface may utilize suggestion models to generate sets of suggestions for a specific visit, such as tests, vaccinations, etc. Owners may be able to evaluate, select, and/or schedule services and products via a user interface provided by the customer experience interface. Owner may be able to evaluate pricing and review research or information such as instructional videos, consumer reviews, and/or other appropriate data. A visit plan may be generated and visit management may allow feedback to be received from practitioners and owners during a visit. Upon completion of a visit or other provision of goods or services, the customer experience interface may facilitate billing, payment, checkout, and discharge.

### BACKGROUND

Many people own or care for pets or service animals. Receiving veterinary care can be time-consuming, confusing, and inefficient. Services and products such as medications may be provided by, or via, disparate resources that require multiple points of interaction to evaluate and select needed or desired services or products.

Therefore there exists a need for a way to provide veterinary services effectively and efficiently via an integrated interface.

### BRIEF DESCRIPTION OF THE SEVERAL VIEWS OF THE DRAWING

The novel features of the disclosure are set forth in the appended claims. However, for purpose of explanation, several embodiments are illustrated in the following drawings.

FIG. 1 illustrates an example overview of one or more embodiments described herein, in which a customer experience interface generates and sends an appointment reminder to a user;

FIG. 2 illustrates an example overview of one or more embodiments described herein, in which a visit plan is generated;

FIG. 3 illustrates an example overview of one or more embodiments described herein, in which a visit is conducted;

FIG. 4 illustrates a two-dimensional image of a graphical user interface (GUI) of one or more embodiments described herein, in which a visit plan is developed;

FIG. 5 illustrates a schematic block diagram of a customer experience interface of one or more embodiments described herein;

FIG. 6 illustrates a schematic block diagram of an environment of one or more embodiments described herein;

FIG. 7 illustrates a flow chart of an exemplary process that generates an appointment reminder;

FIG. 8 illustrates a flow chart of an exemplary process that generates a visit plan;

FIG. 9 illustrates a flow chart of an exemplary process that manages a visit;

FIG. 10 illustrates a flow chart of an exemplary process that facilitates checkout and discharge;

FIG. 11 illustrates a flow chart of an exemplary process that updates suggestion models; and

FIG. 12 illustrates a schematic block diagram of one or more exemplary devices used to implement various embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a customer experience interface that facilitates efficient visit management for veterinary practices. The customer experience interface may allow consumers to review information and costs associated with services and/or products provided by, or via, a veterinary practice. The customer experience interface may be provided via one or more resources such as web-based applications, user device applications, application programming interfaces (APIs), etc.

The customer experience interface may receive information from a resource such as the veterinary practice. Such information may include, for instance, information related to owners, pets, services, products, scheduling, etc. The customer experience interface may be able to interact with various practice management resources (e.g., software, devices, etc.) that may be associated with one or more veterinary practices. For example, the customer experience interface may extract appointment and/or reminder information.

The customer experience interface may utilize various models or rules to generate suggestions related to available services, products, etc. offered by a resource such as a veterinary practice. Such models or rules may be based on machine learning or other artificial intelligence. The models or rules may be associated with, for instance, scheduling (e.g., recommended or due date for a next visit), services or treatment (e.g., vaccinations that are currently due or overdue, recommended tests, etc.), products (e.g., recommended food based on known dietary restrictions or previous evaluation information), and/or other relevant events, attributes, or parameters associated with pet care, evaluation, and/or treatment.

The customer experience interface may generate various user interface (UI) features that may be used to provide various care options to a consumer user such as a pet owner. For instance, a reminder UI may include a listing of services or medication refills that are coming due and may further include options related to pricing, service level, brand, source, etc. The consumer user may be able to select from various services and/or products and generate a visit plan or summary that may be sent to the veterinary practice via a resource such as the practice management resource(s).

The veterinary practice may act on the visit plan in various ways. For instance, the veterinary practice may order, or set aside, requested medications or other supplies. As another example, the veterinary practice may schedule use of equipment (e.g., an ultrasound may be reserved based on described symptoms or ongoing issues) or other resources (e.g., an anesthesiologist may be reserved if a teeth cleaning is scheduled).

During a visit, the customer experience interface may allow for real-time updates, analysis, presentation and selections of options, and/or other interactions. For instance, a technician may complete a parasite test and the results may be provided to the consumer user via the customer experience interface. If the test is positive, the user may be able to select from various treatment methods, medication forms, etc. via the customer experience interface. The customer experience interface may provide feedback such as cost, expected duration, and/or other relevant feedback that may allow a user to make informed selections.

In some embodiments, a user may be able to access reference materials, consumer reviews, and/or other data associated with services, treatments, medications, other products, etc. via the customer experience interface.

Once a user has selected and/or authorized services or products, the veterinary practice may deliver such services or products. At discharge or checkout, the customer experience interface may generate and send an invoice or other billing information to the veterinary practice, where the user may then pay via conventional methods. In some embodiments, payment may be processed via the customer experience interface and a payment receipt or other certificate may be provided to the veterinary practice.

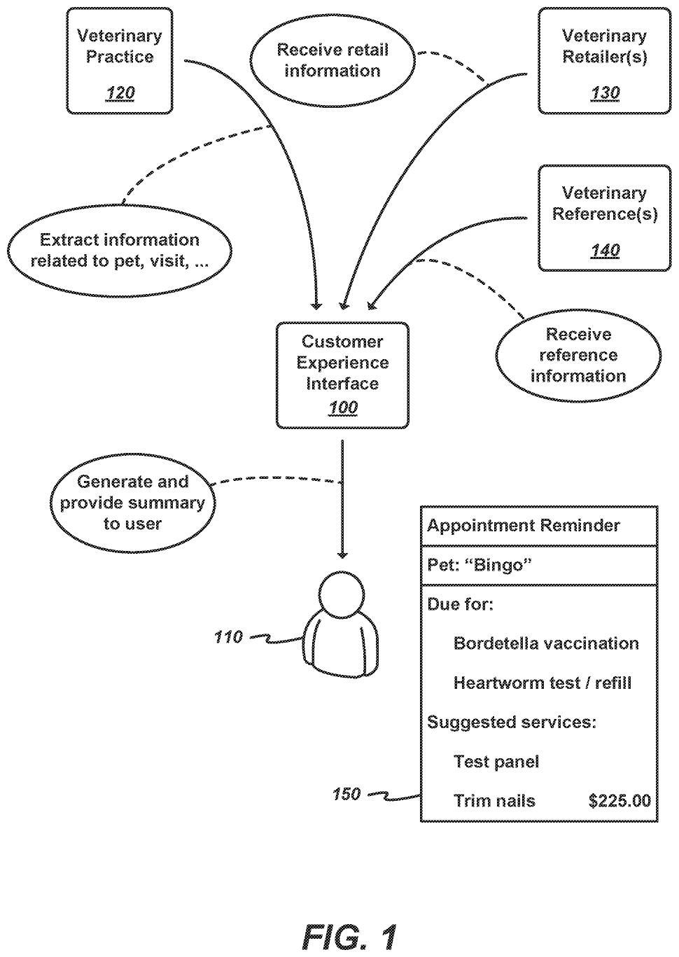

FIG. 1 illustrates an example overview of one or more embodiments described herein, in which a customer experience interface 100 generates and sends an appointment reminder to a user 110. Appointment reminders and/or other types of events or triggers may be generated or initiated by various appropriate resources or parties, such as veterinary practice 120, user 110, veterinary retailers 130, veterinary references 140, and/or other appropriate resources or parties. A similar approach may be used for various other types of initiation events or triggers, such as when an owner brings a pet to a veterinary office for evaluation without a previously scheduled appointment. Although many examples throughout this disclosure may refer to pets, one of ordinary skill in the art will recognize that similar features and algorithms may be applied to various other use cases, such as managing veterinary care for service animals, working animals, livestock, etc.

In this example, user 110 may be an owner of a dog named “Bingo”. Bingo may have previously visited veterinary practice 120 and may be due for a regular examination such as a yearly examination. A resource of the veterinary practice 120, such as a staff member, practice management software, calendar service, and/or other appropriate resource, may initiate an appointment reminder (e.g., one month before the yearly examination is due). As another example, the user 110 may initiate an appointment in a similar manner and some user input may serve as the trigger or initiation event. In some embodiments, customer experience interface 100 may maintain schedules or calendars associated with evaluation, treatment, medication, etc. The customer experience interface 100 may generate the trigger or initiation event in this example based on, for example, a stored date of a previous yearly examination, and an associated suggestion model.

Regardless of the trigger or initiation event, customer experience interface 100 may extract information related to the pet, visit, owner, etc. from information received via one or more veterinary practices 120. The customer experience interface 100 may receive retail information from various relevant veterinary retailers 130 and receive relevant reference information from various veterinary references 140. Such information may be received in various appropriate ways, such as via databases, APIs, storages, etc. Customer experience interface 100 may support a variety of ways to perform authorization and/or authentication in order to gain access to the information associated with the veterinary practices 120, veterinary retailers 130, veterinary references 140, and/or other appropriate resources.

Extracted pet information may include information such as breed, weight, age, and/or any other information relevant to pet care. Extracted visit information may include information such as visit type (e.g., yearly examination, follow-up, initial evaluation, etc.), previous visit date(s) and/or types, medications, conditions or issues, due dates, and/or other information relevant to pet care. Extracted owner information may include information such as contact information, payment or billing information, associated pet(s), etc. Various other types of information may be received and/or extracted from various appropriate resources by customer experience interface 100.

In this example, Bingo may be due for a Bordetella vaccination and a heartworm test and medication refill at the next yearly examination. Further, in this example, the veterinary practice 120 may have recommended that a test panel, such as a blood chemistry panel, be performed to evaluate kidney function based on previous history indicating a chronic condition.

In some embodiments, the customer experience interface 100 may store or extract such information automatically from data received from veterinary practice 120. For instance, customer experience interface 100 may apply sets of evaluation rules to the received data in order to generate relevant and useful data. As one example, a rule associated with Bordetella vaccination may indicate that the vaccination is due every twelve months and data extracted from a veterinary practice 120 may indicate the most recent date that a Bordetella vaccination was administered, from which a next deadline may be automatically calculated. As another example, a rule associated with kidney health may indicate that a test panel should be performed based on previous test data extracted from a veterinary practice 120 indicating a chronic kidney condition (e.g., blood urea nitrogen above a specified threshold). As yet another example, customer experience interface 100 may evaluate visit history for Bingo and determine that the owner has requested nails to be trimmed at previous yearly examinations and may suggest that a nail trim be performed at the next visit.

Retailer information may include information such as listings of available medications or other products, prices, offers or specials, and/or other relevant information. Retailer information may be received from various veterinary retailers 130 and/or veterinary practices 120. In some cases, a veterinary practice 120 may indicate a set of associated veterinary retailers 130 that may provide products or services via the veterinary practice 120 and/or via other facilities. Customer experience interface 100 may extract relevant information based on various relevant factors. For instance, in this example, information associated with heartworm medications may be collected from various veterinary retailers 130 that may or may not be associated with veterinary practice 120. Further, in this example, information associated with the cost of a test panel may be collected from the veterinary practice 120 and/or a set of lab service providers associated with the veterinary practice 120.

Reference information may include information such as recommended treatment schedules, descriptions of medications, instructions, and/or other relevant information associated with pet care. Reference information may be received from various veterinary references 140 and/or veterinary practices 120. In this example, reference information associated with Bordetella, heartworm, and kidney failure may be collected.

In some embodiments, customer experience interface 100 may include, access, maintain, and/or otherwise implement one or more veterinary references 140 associated with education, recommendations, guidelines, instructions, and/or other information related to pet care. Such information may include multimedia presentations and/or audiovisual content provided by practitioners such as doctors, nurses, technicians, nutritionists, and/or other appropriate personnel. For instance, in this example instructions related to heartworm medication and chronic kidney conditions may be collected. As another example, information associated with the breed may be collected and/or filtered in various ways (e.g., by expected onset age).

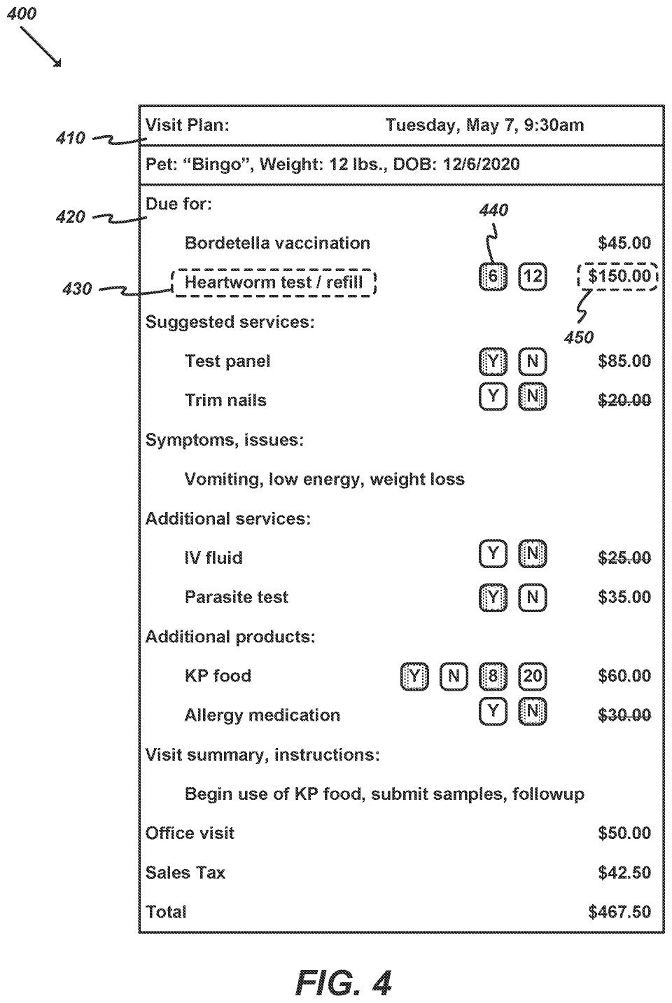

Customer experience interface 100 may generate and provide a summary and/or other appointment reminder 150 to the user 110 based on the received and extracted information. The appointment reminder 150 may be provided via a resource such as a web-based application or user device application. The appointment reminder 150 may be provided via a GUI and/or other appropriate ways. In this example, various details have been omitted for clarity. Customer experience interface 100 may include elements such as data (e.g., reminder type, due date, previous visit information, suggested services, etc.), input element (e.g., selection menus, buttons, etc.), calculated or generated outputs (e.g., estimated cost, visit duration, etc.), and/or other appropriate elements (e.g., a multimedia player, links to external resources, etc.). Such GUIs will be described in more detail in reference to FIG. 4 below.

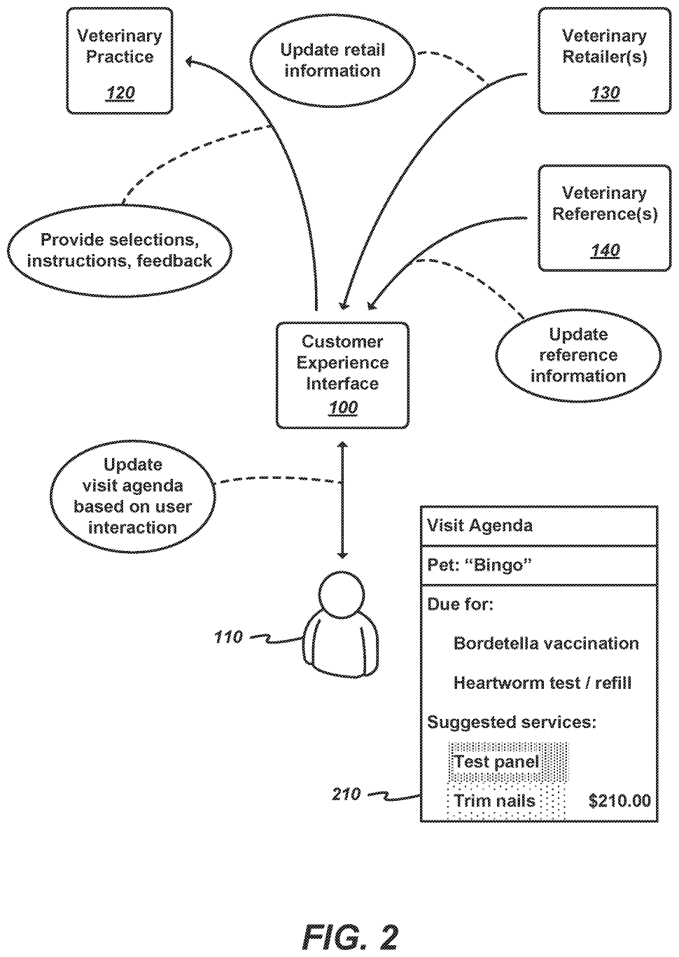

FIG. 2 illustrates an example overview of one or more embodiments described herein, in which a visit plan is generated. In this example, a user 110 may have received an appointment reminder such as appointment reminder 150. Alternatively, a request to schedule an appointment or otherwise consult with a veterinary practice 120, veterinary retailer 130, and/or veterinary reference 140 may be initiated by a user 110 (e.g., by navigating to a web-based application of some embodiments, by launching a user device application of some embodiments, etc.) and appointment reminder 150 (or a similar interface) may be generated or utilized by customer experience interface 100 to provide information to a user 110 and receive various user inputs.

Customer experience interface 100 may generate a visit agenda 210 that may be provided via a resource such as a web-based application or user device application. The visit agenda 210 may be provided via a GUI, such as the same or a similar GUI to that used to provide appointment reminder 150. Visit agenda 210 may provide various interface elements that may allow a user 110 to, for instance, select from available appointment times, select goods and/or services, research conditions or treatments, and/or otherwise evaluate options and schedule an appointment.

In this example, user selections may indicate that the test panel is approved or requested and the nail trim is denied or not requested (as indicated by the different fill patterns). As such, the total price is updated to reflect the change in services. A user 110 may utilize visit agenda 210 to select additional goods or services, approve or deny suggested goods or services, upgrade or downgrade goods or services, and/or otherwise modify requested goods services (e.g., by changing a quantity of a medication or treatment). In addition, visit agenda 210 may provide, or link to, reference information, instructional videos, etc. For example, user 110 may be able to evaluate the need for a test panel based on previous measurements and guidelines provided by veterinary practices 120 (e.g., a recommendation from a veterinarian that has previously treated Bingo), veterinary references 140 (e.g., educational web sites, social media groups, etc.), and/or other appropriate resources.

As services and/or goods are selected and/or deselected, the total price, visit duration, and/or other information may be updated via the visit agenda 210 or other interface. In addition, options such as medication quantities may be evaluated, such as providing pricing received from veterinary retailers 130 for different brands of heartworm medication, different quantities of medication (e.g., a three month versus six-month supply), and/or other relevant information (e.g., associated coupons, discounts, offers, etc.).

Depending on the specific goods and/or services, various rules may prevent certain selections or options. For instance, heartworm medication may not be able to be ordered unless a test is scheduled for the same visit, or a previous test is identified that satisfies the associated rule (e.g., a test must have been administered within the previous six-month period). In some cases, warnings or partial restrictions may be implemented, depending on the nature of the selections and evaluation of relevant data. For instance, if the user 110 attempts to cancel the Bordetella vaccination, a warning or instruction may be provided that indicates the benefits of vaccination, restrictions that may be applied (e.g., limitations on travel or boarding), legal requirements (e.g., indicating that certain vaccinations are required at various intervals for animals within some city limits), etc.

The visit agenda 210 may allow a user 110 to enter questions, request advice or special services, and/or otherwise communicate with the veterinary practice 120. For instance, the user 110 may indicate that Bingo has been lethargic with a reduced appetite. As another example, a user 110 may request evaluation of a specific issue or area (e.g., slight limp at front left leg).

In some cases, a user 110 may be able to select among veterinary practices 120 that are able to provide the desired services and/or goods. For example, if a user 110 has requested evaluation that requires specialized equipment such as an ultrasound, the specialized equipment may only be available at some facilities.

Once the user 110 has evaluated the options and made final selections via the visit agenda 210, customer experience interface 100 may generate instructions and/or feedback and deliver the selections, instructions, and/or feedback to one or more veterinary practices 120, as appropriate. The instructions may include information such as, for instance, requested appointment time, goods and/or services, medication types and/or brand, etc. The veterinary practice 120 may receive the information and prepare for the visit accordingly (e.g., by scheduling equipment or other resources, by ordering medication or other supplies, etc.).

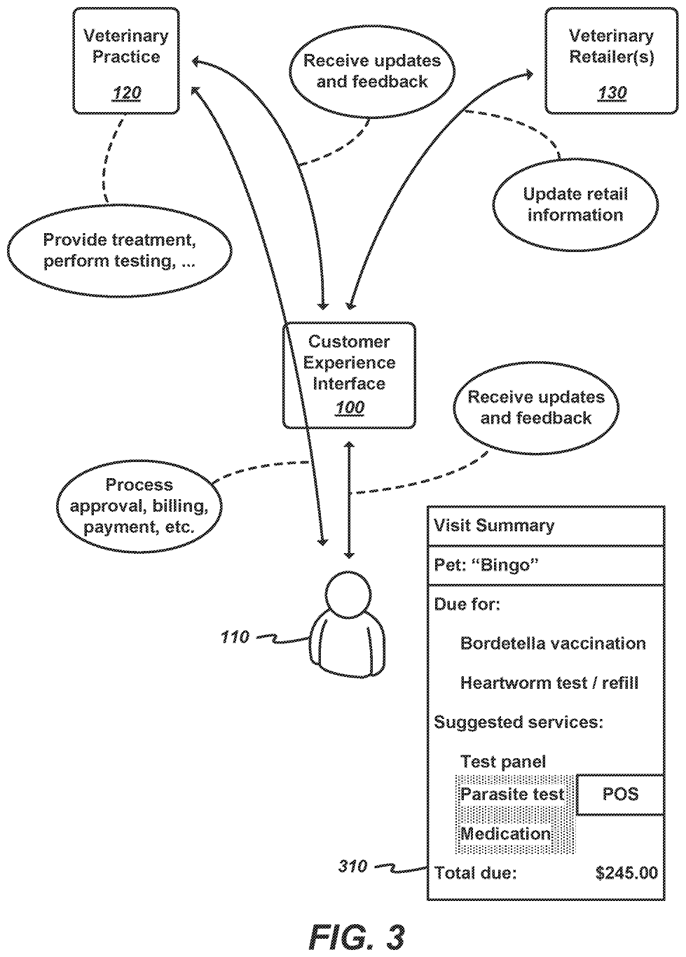

FIG. 3 illustrates an example overview of one or more embodiments described herein, in which a visit is conducted. In this example, visit summary 310 may be generated or utilized by customer experience interface 100 and provided to user 110. Visit summary 310 may be generated during or after a visit or consultation with a resource such as a veterinary practice 120.

In this example, veterinary practice 120 may have recommended a test panel including a “parasite test” in addition to a Bordetella vaccination and a heartworm test and refill that may have been previously selected or authorized by user 110. Updates and feedback may be provided to the user 110 via the customer experience interface 100. For instance, a message or other indication may be sent from the veterinary practice 120 to the customer experience interface 100 indicating that a resource of the veterinary practice 120 has recommended the parasite test. Similarly, updates and feedback may be provided to the veterinary practice 120 via the customer experience interface 100. For instance, a message or other indication may be sent from the customer experience interface 100 to the veterinary practice 120 indicating that the user 110 has authorized the parasite test.

Test results, other evaluation data, treatment status, and/or other visit information may be provided via the visit summary 310. The visit summary 310 may be provided via a GUI, such as the same or a similar GUI to that used to provide appointment reminder 150 and/or visit agenda 210. Continuing the example, the parasite test may indicate a positive result, where such result may be based on examination and/or other evaluation performed using veterinary practice 120 resources, such as veterinarians, nurses, technicians, test equipment, medical evaluation devices or systems, etc. In this example, a parasite test may be performed via visual inspection using a resource such as a microscope. The result in this example is simply “POS” or “positive”.

Different types of tests may include various different result types, such as discrete values (e.g., “positive”, “negative”, “inconclusive”, “within normal range”, “outside normal range”, etc.), measured values or attributes (e.g., albumin levels, total protein, complete blood count, white blood cell count, etc.) provided in various appropriate units, relative values (e.g., percentage, grade, etc.), conclusive and/or advisory values (e.g., “healthy”, “chronic condition”, etc.), and/or any other appropriate results.

Based on the positive test result in this example, a prescription medication may be recommended via visit summary 310. User 110 may be able to evaluate and/or authorize the medication via the visit summary 310 GUI. For example, the cost of the medication may be provided. As another example, different types or forms of medication may be offered (e.g., pills, liquid, etc.). As another example, treatment options may include treatment provided by the veterinary practice 120 (e.g., administering a shot, delivering intravenous fluid, etc.), home treatment options (e.g., pills or ointments to be administered over a period of time), and/or combined or mixed treatment options.

As the veterinary practice 120 provides treatment, performs testing, determines test results, and/or otherwise evaluates or cares for a pet, the visit summary 310 may be further updated. For example, an indication of a negative heartworm test result may be received from the veterinary practice 120 and may be provided to the user 110 via the visit summary 310. Further, the negative result may trigger or authorize refill of heartworm medication, where medication options (e.g., substances, brands, quantities, etc.) may be evaluated and selected by user 110 via the visit summary 310.

As such selections are received from a user 110 and/or information is received from veterinary practice 120, customer experience interface may update retail information available from veterinary retailers 130. For instance, if heartworm medication has been selected and/or authorized, product information such as available brands, quantities, substance, rebates or coupons, etc. related to appropriate heartworm medication may be received from the veterinary retailers 130.

The user interface experience 100 may receive user updates and feedback as additional options are made available (e.g., when a medication is approved or recommended), test results or other feedback is received, user selections are applied, and/or under other appropriate circumstances.

Once all services have been provided by the veterinary practice 120 checkout and/or discharge may be facilitated via the customer experience interface 100. Customer experience interface 100 may process approvals, billing, payment, and/or perform other relevant operations (e.g., updating one or more databases associated with the pet, owner, facility, etc.). For instance, the veterinary practice 120 may send a final invoice or visit summary 310 for approval and/or payment. Customer experience interface 100 may receive approval and/or payment information from user 110 (e.g., a user 110 may associate a credit card, digital wallet, bank account, and/or other payment information with a customer experience interface 100 account), and/or provide such information to other entities (e.g., practice management systems associated with veterinary practice 120).

FIG. 4 illustrates a two-dimensional image of a graphical user interface (GUI) 400 of one or more embodiments described herein, in which a visit plan is developed. GUI 400 may be provided via various appropriate resources, such as a web-based interface, user device application, etc. As shown, in this example, the GUI 400 may include a title or header area 410, an interactive element area 420, various text and/or graphic indicators or elements 430, various selection or input elements 440, and various output elements 450.

Title or header area 410 may include various informational elements, such as a title, visit date, pet name and information, and/or other relevant information such as previous visit(s), existing conditions, medications, etc. Interactive element area 420 may include various elements that may present options or suggestions and/or receive user inputs. GUI 400 may include various other areas or elements, as appropriate.

Each text and/or graphic indicator or element 430 may include text, graphics, and/or other visual indicators. In some embodiments, text and/or graphic indicators or elements 430 may provide information via audio or otherwise make the GUI 400 accessible to those with visual impairments. Text and/or graphic indicators or elements 430 may serve as input elements 440 in some cases. For example, text may be associated with a uniform resource locator (URL) the points to a resource such as an appropriate veterinary reference 140 (e.g., a web page providing indications, and/or other information associated with a medication). In some embodiments, GUI 400 may include or utilize elements such as pop-up windows, media players, etc. that may be used to present relevant content based on received selections or information. For example, in some embodiments, customer experience interface 100 may provide access to a library of videos or other media, where medical professionals discuss treatment options, benefits or drawbacks, medications, and/or otherwise provide relevant information related to evaluation, treatment, and/or care for pets or other animals.

Each selection or input element 440 may include various features, such as radio buttons, drop-down menus, pop-menus, etc. that may allow selection among various options. For example, selection input elements 440 may allow for selection among different treatment options, medications, quantities, etc. In this example, selections options include discrete values (e.g., approval or denial of authorization to perform a service or provide some product, a number of doses of a medication when multiple options are available, etc.), inputs that allow values to be typed or otherwise entered (e.g., using speech-to-text), line or paragraphs inputs that accept strings of text (e.g., allowing a user 110 to type questions, provide assessments or updates, etc.), and/or any other GUI elements that may accept inputs from a user 110 or other external resource.

Each output element 450 may include calculated, determined, matched, or otherwise generated values. For instance, in this example, a cost of each treatment option may be provided via the output elements 450. As another example, a recommendation may be automatically provided based on received inputs. For instance, pet type, breed, and/or age may be received and various suggested services or options may be provided based on the entered information.

In this example, GUI 400 may allow a user 110 to evaluate different services and/or products and generate estimated expenses based on the entries. GUI 400 may include an action element (e.g., a “book appointment” button, not shown) that may generate a summary of the visit plan and/or initiate various messages (e.g., a booking message may be automatically generated and sent to a veterinary practice 120, an email confirmation to the user 110, an order or stocking information to a veterinary retailer 130, etc.).

One of ordinary skill in the art will recognize that different embodiments may include various different elements, arrangements of elements, and/or otherwise be different that the example GUI 400. In this example, GUI 400 may be intended for use by an owner user 110. The same or similar GUIs may be provided by customer experience interface 100 to other entities, such as users associated with a veterinary practice 120 (e.g., veterinarians, technicians, staff, etc.), users associated with veterinary retailers 130, users associated with veterinary resources 140, and/or other appropriate entities.

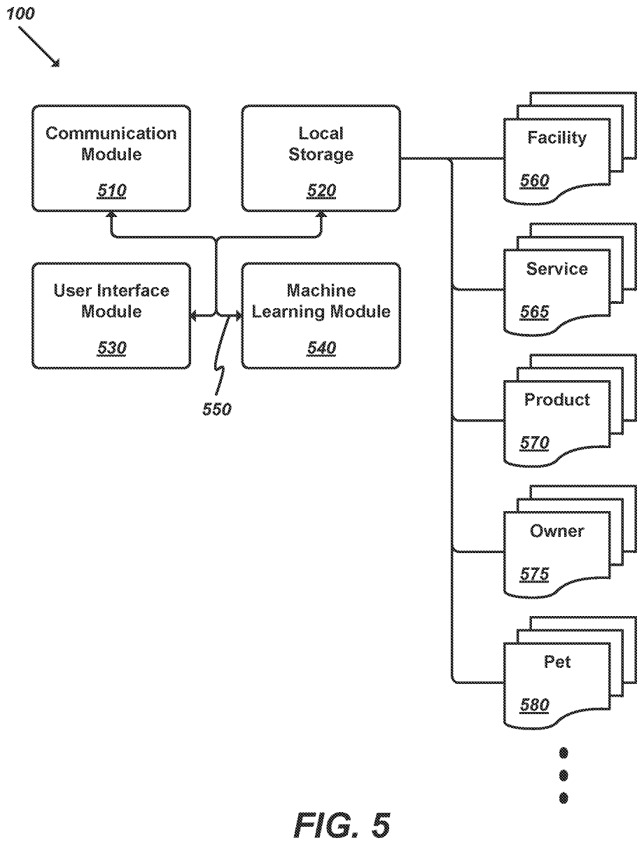

FIG. 5 illustrates a schematic block diagram of a customer experience interface 100 of one or more embodiments described herein. As shown, the customer experience interface 100 may include a communication module 510, local storage 520, user interface module 530, machine learning module 540, communication bus 550, and/or other appropriate components.

Customer experience interface 100 may be implemented using various specific devices, components, and/or systems. For instance, customer experience interface 100 may be implemented via, or using, at least one server. As another example, customer experience interface 100 may be implemented via, or using, a network-accessible storage or other resources (e.g., one or more APIs). Customer experience interface 100 may be implemented via, or using, various user devices (e.g., smartphones, tablets, laptops, etc.).

Communication module 510 may be able to interact with various other components, devices, and/or systems via various appropriate communication channels. For example, communication module 510 may be able to send and receive messages across at least one wired or wireless network (e.g., a cellular network, Ethernet, Wi-Fi, etc.). As another example, communication module 510 may be able to send and receive messages across a local wireless channel such as a Bluetooth connection. Communication module 510 may be able to interact using various messaging or communication protocols. Communication module 510 may include various interfaces and/or components that may be able to translate messages or other communications from one format or protocol to another.

Local storage 520 may include various memory elements that may be able to store data and/or instructions. Local storage may store, or otherwise provide access to, resources such as facility element 560, service element 565, product element 570, owner element 575, pet element 580, and/or other appropriate elements, files, data structures, sets of instructions, etc. In this example, local storage 520 is “local” to the customer experience interface 100, but one of ordinary skill in the art will recognize that, such a component (and/or similar functionality) may be provided via, or using, a set of one or more remote storages, network resources (e.g., APIs), and/or other appropriate resources.

Each memory element 560-580 may include elements such as a unique identifier (e.g., a serial number), a name (e.g., “Main Street Animal Hospital”), a type (e.g., “facility”, “service”, “product”, “owner”, “pet”, “other”, etc.), description (e.g., a product description, service description, etc.), demographic information (e.g., pet breed and age, owner billing address, facility location, product manufacturer, etc.), references or links to other elements or data (e.g., a prescription medication may be associated with a product element 570 that is referenced by various pet elements 580 associated with pets that have been prescribed the medication and/or may be referenced by various facility elements 560 that may provide the prescription medication), and/or other appropriate elements.

Each facility element 560 may include information and/or references related to a facility such as a veterinary practice 120, an animal hospital, specialized care facilities, etc. Each service element 565 may include information and/or references related to a different service, such as examination or evaluation, testing, treatment, grooming, etc. Each product element 570 may include information and/or references related to a different product, such as medications, food, medical supplies (e.g., braces or supports, Elizabethan collars, syringes, cannulas, intravenous fluids, etc.), tools (e.g., nail clippers, brushes, etc.), etc. Each owner element 575 may include information and/or references related to an owner or caretaker, entity or group, etc. Each pet element 580 may include information and/or references related to a pet or set of pets.

Various other elements may be included and/or utilized by various different embodiments. For example, some embodiments may include a “visit element” or other similar element associated with each visit to a facility, and indicate or include information such as references to an owner 575, pet 580, facility 560, services 565, products 570, and/or other appropriate information (e.g., date of service, recommendations or notes, test results, etc.). As another example, a “doctor element” or “technician element” may be associated with a facility resource such as a veterinarian or technician and may include or indicate, for example, references to visit elements, pet elements 580, service elements 565, demographic information (e.g., name, specialty or training, certifications, etc.), and/or other relevant information. As still another example, various models, parameters, attributes, etc. associated with machine learning or artificial intelligence may be utilized by some embodiments of the customer experience interface 100.

User interface module 530 may receive inputs from, and provide information to, a user 110 or other appropriate resource. User interface module 530 may generate and/or manage GUIs such as GUI 400. In some embodiments, user interface module 530 may include one or more interfaces, such as APIs, which may allow interaction with entities such as servers, practice management software, and/or other automated entities or resources.

Machine learning module 540 may implement various machine learning algorithms to generate and/or update recommendations, user interface features or options, and/or otherwise facilitate pet care, evaluation, and/or treatment. Machine learning module 540 may be associated with various models or other elements (not shown) that may direct the machine learning and/or implement various suggestion algorithms, and/or other types of algorithms. Machine learning module 540 may implement machine learning models using various types of learning, such as supervised, unsupervised, or reinforcement learning.

Machine learning module 540 may train models using data extracted from local storage 520 and/or other appropriate data (e.g., network-accessible databases associated with pet care, treatment, medications, etc.). Machine learning module 540 may generate feedback or otherwise evaluate the models and/or may receive feedback from external sources (e.g., a team of veterinary practitioners may review and grade suggestions provided by the models). Models may be updated based on feedback from users 110, whether direct or indirect. For instance, if a user selects a service associated with a particular model, the particular model may be more likely to be utilized and/or weighted more heavily in the future. In contrast, if a user does not select any services associated with a particular model, the particular model may be less likely to be utilized and/or weighted less heavily in the future. Similarly, if a model generates a list of suggested services, and users 110 select a particular service from the list more often than others, that particular service may be more likely to be suggested by an updated version of the model, while services that are not selected may be less likely to be suggested by the updated model.

In addition to, or in place of, such machine learning features (e.g., machine learning models), some embodiments of the customer experience interface may utilize rules (e.g., suggestion rules) that may be defined by practitioner-users such as veterinarians. For instance, a rule associated with Bordetella vaccination may recommend vaccination every six months regardless of, for example, a machine learning model indicating the owner-user 110 is unlikely to select or authorize the vaccination. Such rules and machine learning models may be utilized according to various weighting or other ways of generating suggestions based on the available rules and/or models.

One of ordinary skill in the art will recognize that customer experience interface 100 may include various different components, arrangements of components, communication pathways, etc. without departing from the scope of the disclosure. For example, customer experience interface 100 may include one or more processing modules or control modules that may direct other components of the customer experience interface 100 and/or interact with other components, devices, and/or systems.

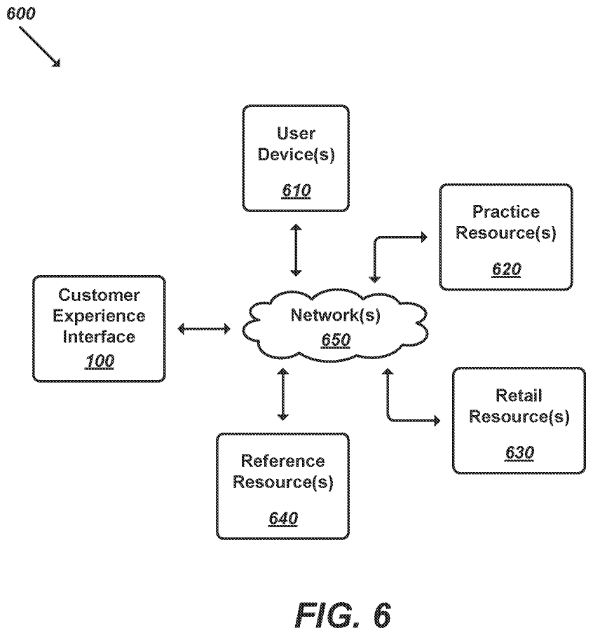

FIG. 6 illustrates a schematic block diagram of an environment 600 of one or more embodiments described herein. As shown, environment 600 may include customer experience interface 100 and one or more user devices 610, practice resources 620, retail resources 630, reference resources 640, and/or networks 650.

Customer experience interface 100 may include various components, devices, and/or systems that may be able to execute instructions and/or otherwise process data. Customer experience interface 100 may include, utilize, or otherwise be implemented via devices such as user device 610, servers, storages, and/or other appropriate devices.

Each user device 610 may be an electronic device, system, or set of components that is able to execute instructions and/or otherwise process data. User device 610 may be, include, utilize, and/or otherwise be implemented via a device such as a smartphone, tablet, wearable device (e.g., a smartwatch), PC, laptop, and/or other similar device.

Each practice resource 620 may be, include, utilize, and/or otherwise be implemented via a device, or set of devices, such as a user device 610, workstation, etc. In some cases, practice resources 620 may implement, utilize, and/or otherwise be associated with, various practice management resources (e.g., practice management software, online databases, etc.). Veterinary practice 120 may be one example of a practice resource 620.

Each retail resource 630 may be, include, utilize, and/or otherwise be implemented via a device, or set of devices, such as a user device 610, workstation, etc. Retail resources 630 may be associated with ecommerce sites and/or other appropriate resources that may allow for evaluation and purchase of retail items such as medications. Veterinary retailer 130 may be one example of a retail resource 630.

Each reference resource 640 may be, include, utilize, and/or otherwise be implemented via a device, or set of devices, such as a user device 610, workstation, etc. Reference resources 640 may be associated with resources such as servers and/or online storages that may provide reference information. In some embodiments, such reference information may include multimedia such as instructional videos, informational pamphlets, etc. Veterinary reference 140 may be one example of a reference resource 640.

Network 650 may allow communication among components, devices, and/or systems. Network 650 may provide, include, utilize, and/or otherwise be associated with, one or more communication pathways, such as cellular networks, Wi-Fi networks, wired networks such as Ethernet, wireless communication channels such as Bluetooth, the Internet, and/or other appropriate communication pathways.

One of ordinary skill in the art will recognize that environment 600 may include various different components, arrangements of components, communication pathways, etc. without departing from the scope of the disclosure.

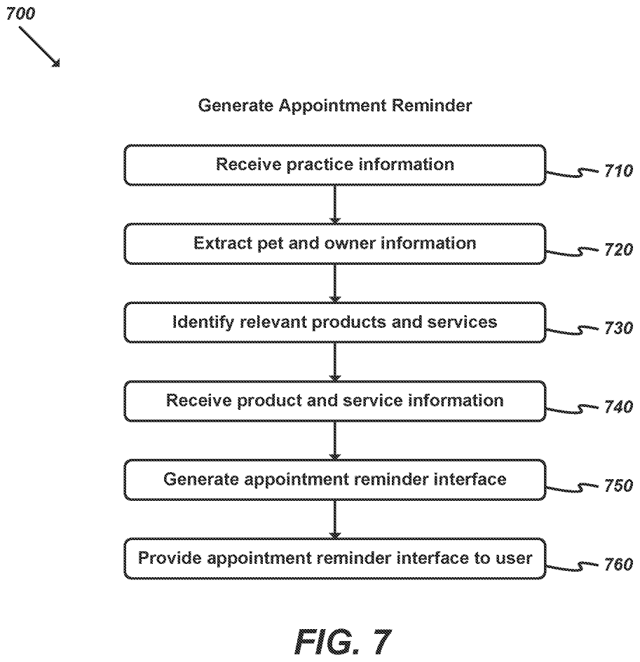

FIG. 7 illustrates an example process 700 for generating an appointment reminder. The process may use suggestion rules or other resources to evaluate a pet associated with an upcoming visit and generate an appointment reminder 150 or other appropriate user interface elements. The process may be performed based on various appropriate triggers, such as a reminder generated by practice management or scheduling software associated with a veterinary practice 120 that is received by customer experience interface 100. In some cases, customer experience interface 100 may generate a trigger based on a calendar or similar resource, previous visit data, and/or one or more suggestion models or rules associated with scheduling. In some embodiments, process 700 may be performed by customer experience interface 100. Process 700, and/or one or more complementary or otherwise associated processes, may be at least partly performed by resources such as user device(s) 610, practice resource(s) 620, retail resource(s) 630, reference resource(s) 640, and/or other appropriate resources.

As shown, process 700 may include receiving (at 710) practice information. Such information may be received at the customer experience interface 100 from or via a resource such as practice resource 620. For example, practice resource 620 may be associated with an API or other appropriate resource that may be utilized by customer experience interface 100. As another example, customer experience interface 100 may send a request message, or set of messages, to practice resource 620 and receive a response message, or set of messages, that includes the practice information. Practice information may include, for instance, listings of services and/or products provided via the practice, pricing information, available personnel such as doctors and technicians, calendar or scheduling information (e.g., available appointment times), and/or other appropriate information.

Process 700 may include extracting (at 720) pet and owner information. Such information may be extracted from the information received from the practice resource 620 and/or other appropriate resources, such as local storage 520, reference resources 640, etc. Each owner-user 110 may be associated with a resource such as a customer experience interface account, which may be associated with identification, authorization, and/or authentication features such as a username and password. Pet information may include, for example, elements such as type, breed, age, treatment history, etc. Owner information may include, for example, elements such as demographic information, payment information, preference or selections, etc.

The process may include identifying (at 730) relevant products and services. Relevant products and services may be identified using resources such as suggestions rules, machine learning models, services available via a particular veterinary practice 120, etc. For example, a suggestion rule associated with heartworm treatment for a dog may include a rule that indicates a test should be performed every six months and that medication should be given one a month. Based on such a rule, a suggestion to refill heartworm medication may include information such as previously used medication, brand, quantity purchased, etc. Relevant products and services may include, if available, the same quantity, brand, and type of medication from the same supplier or source. In some embodiments, suggestion rules or models may include alternative options, such as other medications, brands, quantities, suppliers, etc. As another example, a suggestion rule associated with nail trimming may suggest a nail trim if one has not been performed within the previous three months.

Customer experience interface 100 may receive listings of available services or products and associated information from veterinary practice 120 and/or other practice resources 620 in order to identify relevant products and services. Such availability may depend on various relevant factors that may be utilized by customer experience interface 100 to filter the available options as appropriate. For instance, if a specialist is required for some service, the service may only be offered according to the availability of the specialist (e.g., ultrasound scanning may be available Monday-Friday at a particular practice but not Saturday or Sunday, due to availability of the specialist). As another example, a veterinary practice 120 may have equipment-based limitations. For instance, the veterinary practice 120 may have a single x-ray machine and availability of x-ray services may depend on the operational status of the x-ray machine and/or other scheduled use (i.e., the machine may only be used for one subject at a time and may have a maintenance period between subjects for cleaning, calibration, etc.).

As shown, process 700 may include receiving (at 740) product and service information. Product and service information may be received by the customer experience interface 100 from resources such as practice resources 620 (such as individual veterinary practices 120), retail resources 630, reference resources 640, and/or other appropriate resources. Pricing and/or other information associated with products and services may be received by the customer experience interface 100. For example, estimated time needed to perform the service, technician or groomer that will perform the service, price, etc. associated with a nail trim may be received from various appropriate resources, such as via a practice resource 620, retail resource 630, reference resource 640, etc.

Process 700 may include generating (at 750) an appointment reminder interface. Such an interface may be similar to appointment reminder 150 and/or GUI 400 described above. The interface may be generated based on the practice information, pet and/or owner information, suggested products or services, product and service information, and/or other appropriate information. The appointment reminder interface may include information such as available times to schedule the appointment, contact information for the practice, recommended products and/or services, estimated fees or costs, and/or other relevant information as described herein. Further, as described above, the appointment reminder interface may include various selection or input elements 440 that may allow a user 110 to review, authorize (or deny authorization), and/or otherwise evaluate recommended products and/or services.

The process may include providing (at 760) the appointment reminder interface. The appointment reminder interface may be provided in various appropriate ways. For instance, an email or text message may be generated and sent to a user device 610 by customer experience interface 100. The email or text message may include the appointment reminder interface, provide a link to a web page or application resource, and/or otherwise provide access to the appointment reminder interface (e.g., by storing the interface information at a network-accessible storage). The appointment reminder interface may be provided to a user 110 via a user device 610, for instance via a web browser or dedicated application of some embodiments, and/or via other appropriate resources. As another example, the appointment reminder information may be saved to a resource such as a storage that is accessible via an API. The updated information may be received by resources such as user device 610, practice resources 620, and/or other appropriate devices. Such updated information may be received based on association with various credentials (e.g., an owner-user 110 may be able to receive appointment reminder information for a pet previously associated with the owner-user 110).

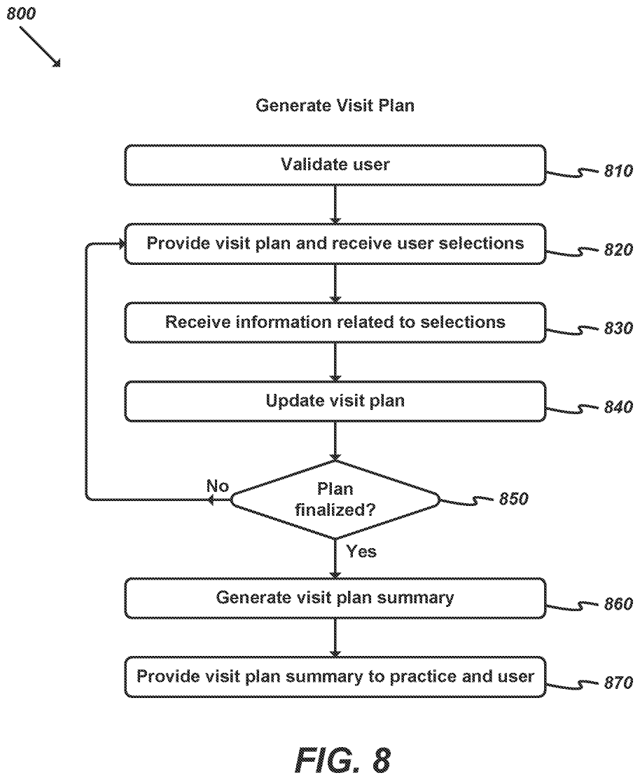

FIG. 8 illustrates an example process 800 for generating a visit plan. The process may receive appointment reminder information, such as that provided by process 700 and, using the appointment reminder information, generate a visit plan based on received user selections and/or other appropriate attributes. The visit plan may be used to schedule an appointment and/or otherwise request provision of service or products (e.g., by placing an order for specialized pet food). Process 800 may be performed based on various appropriate triggers, such as when an appointment reminder is generated by customer experience interface 100 and/or when the appointment reminder interface is accessed by a user 110. In some embodiments, process 800 may be performed by customer experience interface 100. Process 800, and/or one or more complementary or otherwise associated processes, may be at least partly performed by resources such as user device(s) 610, practice resource(s) 620, retail resource(s) 630, reference resource(s) 640, and/or other appropriate resources.

As shown, process 800 may include validating (at 810) a user 110. Such validation or authorization may be performed in various appropriate ways. For instance, a user 110 may be associated with a user account having a username and password, where the user 110 may have to correctly enter the username and password to be validated. As another example, a dedicated application of some embodiments may provide a token or other credentials to customer experience interface 100 that may be evaluated and validated. As still another example, validation may be based on access of a link provided via an email or text message. Required validation operations may depend on information associated with the appointment reminder interface and/or associated services or information. For example, a user 110 may have to perform additional validation (e.g., two-step validation) in order to access or modify payment information, but may be able to schedule an appointment without any validation.

Process 800 may include providing (at 820) the visit plan and receiving user selections. The visit plan may be provided via a resource such as the visit plan interface, visit agenda 210, or GUI 400. User selections, such as authorization or denial of recommended services, selections of products, review of reference materials, and/or other user interactions (e.g., typed questions or requests) may be received via a resource such as GUI 400.

The process may include receiving (at 830) information related to the user selections. For instance, if authorization for a test is received, pricing and/or expected duration may be received. As another example, if a heartworm test authorization is received, listings of recommended or appropriate medications may be received, availability verified, and/or coupon information may be received.

As shown, process 800 may include updating (at 840) the visit plan. GUI 400, and/or other appropriate interfaces, may be updated to reflect the current visit plan, based on the received user selections or inputs, available services or products, resource availability, etc.

Process 800 may include determining (at 850) whether the visit plan has been finalized. Such a determination may be made based on various relevant criteria. For instance, GUI 400 may include a “book appointment” or “finalize visit plan” button or similar element that may indicate the visit plan has been finalized. If the process determines (at 850) that the visit plan has not been finalized, the process may repeat elements 820-850 until the process determines (at 850) that the visit plan has been finalized.

If process 800 determines (at 850) that the visit plan has been finalized, the process may include generating (at 860) a visit plan summary, such as visit agenda 210. The visit plan summary may include, for instance, a listing of selected or authorized services or products, pricing information, expected duration, date and time of visit, and/or other relevant information (e.g., practice information, provider or personnel information, etc.).

As shown, process 800 may include providing (at 870) the visit plan summary to the practice and the user. The visit plan summary may be provided in various appropriate ways. For instance, an email or text message may be generated and sent to a user device 610 and/or practice resource 620 by customer experience interface 100. The email or text message may include the visit plan summary, provide a link to a web page or application resource, and/or otherwise provide access to the visit plan summary (e.g., by storing the interface information at a network-accessible storage). The visit plan summary may be provided to a user 110 via a user device 610, for instance via a web browser or dedicated application of come embodiments, and/or via other appropriate resources. The visit plan summary may be similarly provided to a practitioner-user 110 via a practice resource 620 or user device 610. As another example, the visit plan summary information may be saved to a storage that is accessible via API. The updated information may be received by resources such as user device 610, practice resources 620, and/or other appropriate devices. Such updated information may be received based on association with various credentials (e.g., a practice-user 110 may be able to receive visit plan information for an appointment associated with the practice).

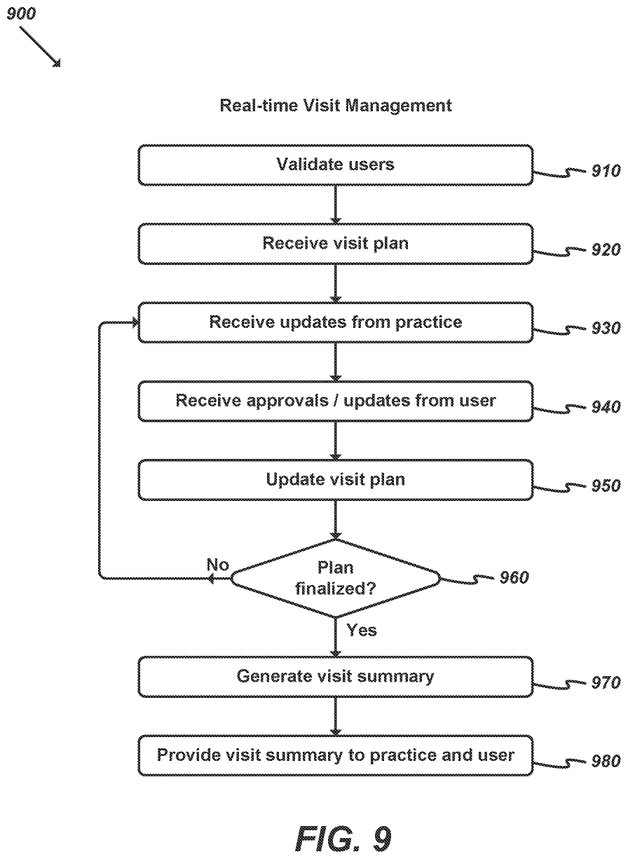

FIG. 9 illustrates an example process 900 for managing a visit. The process may allow interaction between practice resources 620 and/or personnel, and an owner-user 110 during a visit. Services and/or products may be selected, authorized, reviewed, etc. In some embodiments, test results, evaluation results, and/or practitioner review or suggestion information may be received and provided via process 900. The process may be performed based on various appropriate triggers, such as a check-in event indicated by some practice management software associated with a veterinary practice 120 that is received by customer experience interface 100. In some cases, customer experience interface may generate a trigger based on a location or similar resource, previous visit data, and/or one or more suggestion models or rules associated with scheduling. In some embodiments, process 900 may be performed by customer experience interface 100. Process 900, and/or one or more complementary or otherwise associated processes, may be at least partly performed by resources such as user device(s) 610, practice resource(s) 620, retail resource(s) 630, reference resource(s) 640, and/or other appropriate resources.

As shown, process 900 may include validating (at 910) the user(s) 110. Owner-users 110, practice-users 110, and/or other users 110 may be validated in similar ways to those described above in reference to operation 810.1

Process 900 may include receiving (at 920) a visit plan. The visit plan, such as represented by visit agenda 210 may be provided by customer experience interface 110 to resources such as user device 610 and practice resource 620 for presentation to owner-users 110 and practice-users 110.

The process may include receiving (at 930) updates from the practice. Such updates may include, for example, test results, evaluation results, status updates (e.g., “pre-op”, “post-op”, “recovery”, “performing evaluation”, “grooming”, etc.), recommendations, and/or other appropriate updates (e.g., available inventory, available staff or resources, etc.). Per the example above, a parasite test may be performed and the results may be received (at 930) as updates from the practice. Updates may be received via an interface similar to GUI 400.

As shown, process 900 may include receiving (at 940) approvals and/or updates from user 110. For example, the parasite test may be recommended based on practice updates, suggestion rules or models, and/or other relevant factors. The user 110 may indicate approval (or denial) of the test, after reviewing, for instance, cost associated with the test, duration or timing of the test, available staff or resources, etc. Approvals, denials, and/or other updates (e.g., typed questions) may be received via a resource such as GUI 400.

Process 900 may include updating (at 950) the visit plan based on the received updates. As described above, a resource such as GUI 400 may be updated based on the updates received from the practice and/or user 110. Updates may include, for instance, updates to a listing of selected services, products, etc. (e.g., results, approvals, denials, selections of brand or quantity, comments, etc.).

The process may include determining (at 960) whether the visit plan has been finalized. Such a determination may be made based on data received from a practice-user 110, owner-user 110, product suppliers, and/or other appropriate resources. For instance, a practice-user 110 may utilize a resource such as GUI 400 to indicate that all services have been rendered and the pet is ready for checkout. Similarly, an owner-user may utilize a resource such as GUI 400 to indicate final approval, make final selections, and/or indicate acceptance of a bill or invoice. If the process determines (at 960) that the visit plan has not been finalized, the process may repeat elements 930-960 until the process determines (at 960) that the visit plan has been finalized.

If process 900 determines (at 960) that the visit plan has been finalized, process 900 may include generating (at 970) a visit summary. The visit summary may be, or include information, similar to visit summary 310. The visit summary may include a listing of services, products, measurements, test results, other evaluation results, etc.

Process 900 may include providing (at 980) the visit summary to the practice and to user 110. The visit summary information may be sent by the customer experience interface 100 to resources such as a practice resource 620, user device 610, and/or other appropriate resources. Visit summary information may be sent via resources such as email, a dedicated application of some embodiments, a web page or web-based application, etc. In some cases, customer experience interface 100 may save the visit summary information to a resource such as a storage that is accessible via one or more networks, such as via an API. The updated information may be received by resources such as user device 610, practice resources 620, and/or other appropriate devices. Such updated information may be received based on association with various credentials (e.g., an owner-user 110 may be able to receive visit summary information for a pet previously associated with the owner-user 110).

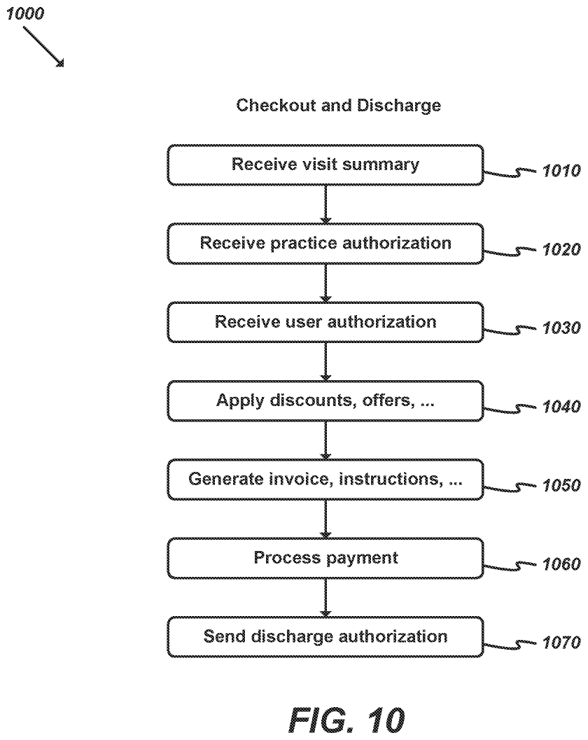

FIG. 10 illustrates an example process 1000 for facilitating checkout and discharge. Such a process may be utilized to facilitate billing, payment, checkout, discharge, and/or otherwise finalize a visit or purchase. The process may be performed based on various appropriate triggers, such as a final visit summary being generated by a process such as process 900. Customer experience interface 100 may generate a trigger based on messages or data received from users 110 (e.g., a checkout request message may be received from a practice resource 620 and/or a checkout acceptance message may be received from a user device 610). In some embodiments, process 1000 may be performed by customer experience interface 100. Process 1000, and/or one or more complementary or otherwise associated processes, may be at least partly performed by resources such as user device(s) 610, practice resource(s) 620, retail resource(s) 630, reference resource(s) 640, and/or other appropriate resources.

As shown, process 1000 may include receiving (at 1010) a visit summary. Such a visit summary may be similar, or include information similar to, visit summary 310. The visit summary may include, for instance, listings of services, results or feedback, costs, charges, etc. and may be generated by a process such as process 900.

Process 1000 may include receiving (at 1020) practice authorization. Such authorization may include, for example, an indication that services have been provided, products are available or have been delivered, and/or otherwise indicate that the pet is ready for discharge and/or that the visit is otherwise ready to be completed. Practice authorization may be received via a set of messages, retrieval of data via an API, and/or other appropriate ways.

The process may include receiving (at 1030) user authorization. User authorization may include, for instance, final approval of goods and services, acceptance of billed amount, etc. User authorization may further include location or availability of the owner-user 110 (e.g., the user 110 may schedule pickup for a specified time). User authorization may be received via a set of messages, retrieval of data via an API, and/or other appropriate ways.

Process 1000 may include applying (at 1040) discounts, offers, rebates, loyalty rewards, and/or other marketing offers. Such offers may be received by customer experience interface 100 from various retail resources 630 and/or practice resources 620. Such rewards or offers may be automatically retrieved based on user account information, purchase history, etc.

As shown, process 1000 may include generating (at 1050) an invoice, instructions, and/or appropriate checkout or discharge information. For instance, the final listing of services, goods, and associated costs may be sent by customer experience interface 100 to a resource such as practice management software, billing software, payment processing resource, and/or other similar resources.

The process may include processing (at 1060) payment. In some embodiments, customer experience interface 100 may directly and/or indirectly facilitate payment. For instance, payment information such as credit card information may be stored by the customer experience interface 100 and may be associated with an owner-user 110 account. Such payment information may be provided to a resource such as a practice resource 620 to process payment. As another example, a payment token may be generated based on the invoice and may be sent to a resource such as practice resource 620 or an online payment processing resource. As still another example, a user 110 may pay the invoice in person, using cash, credit card, or other appropriate payment method at the veterinary practice 120.

As shown, process 1000 may include sending (at 1070) a discharge authorization. Once a payment has been made, or confirmation received that discharge conditions have been satisfied, a discharge authorization may be generated via a set of messages, storage and API, and/or other appropriate resources. The discharge authorization may be received by a resource such as practice resource 620 and/or may be applied via some practice management software or similar resource. The veterinary practice 120 may finalize the discharge and deliver the pet and/or products to the owner-user 110. In some cases, the customer experience interface 100 may provide facilitate identification of the owner-user 110 and/or verification of identity (for instance, when the owner-user 110 enters a facility associated with veterinary practice 120, the location services of user device 610 may be utilized to determine that the user 110 is at the facility and an arrival message may be sent to a practice resource 620).

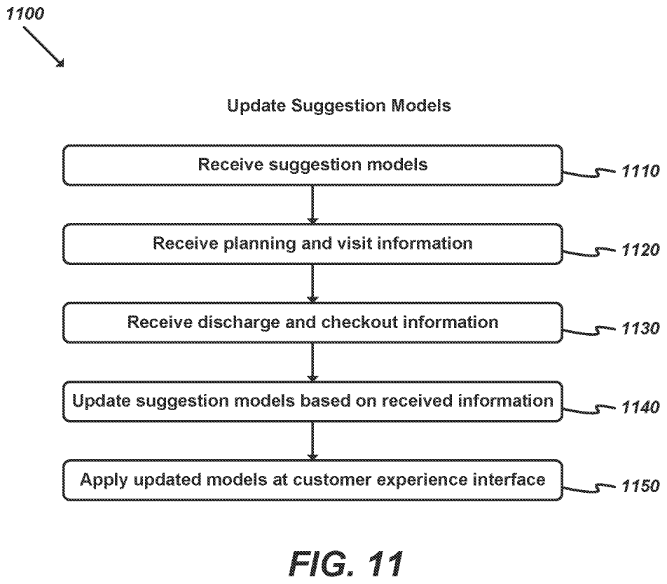

FIG. 11 illustrates an example process 1100 for updating suggestion models, such as machine learning models or suggestion rules. Such a process may allow for optimization of such models based on various types of feedback, such as user selections, test results, treatment results, direct feedback from evaluation resources, etc. The process may be performed based on various appropriate triggers, such as when training data becomes available, at regular intervals, based on administrator-user 110 selections, and/or other appropriate criteria. In some embodiments, process 1100 may be performed by customer experience interface 100. Process 1100, and/or one or more complementary or otherwise associated processes, may be at least partly performed by resources such as user device(s) 610, practice resource(s) 620, retail resource(s) 630, reference resource(s) 640, and/or other appropriate resources.

As shown, process 1100 may include receiving (at 1110) suggestion models. Currently suggestion rules or models may be received from a resource such as local storage 520. Such models may be utilized and/or applied to various aspects of operation of the customer experience interface 100.

Process 1100 may include receiving (at 1120) planning and visit information. Such information may include, for instance, appointment reminder information, visit plan information, visit agenda information, visit summary information, billing information, user selection information, practice feedback, and/or other relevant information.

The process may include receiving (at 1130) discharge and checkout information. Such information may include, for instance, billing information, payment information, instructions, feedback, prescription information, and/or other relevant information.

As shown, process 1100 may include updating (at 1140) suggestion models based on the received information. Updating the models may include evaluating the received information, receiving or generating feedback, and applying the received information and feedback to various machine learning algorithms to improve the suggestion models. For example, a suggestion model associated with heartworm testing and medication may be evaluated based on feedback including the test results, whether user authorized or denied the services, type or other attributes associated with the medication, etc. Thus, for instance, if a particular brand or quantity of medication has been chosen more often than other options, the suggestion model may be updated such that the particular brand or quantity is more likely to be suggested and/or may be presented with a higher priority or placed at a more primary location of GUI 4000.

Process 1100 may include applying (at 1150) the updated models at the customer experience interface 100. For instance, the updated models may be saved to local storage 520. Such updated models may be distributed to various resources associated with customer experience interface 100, such as user devices 610, practice resources 620, retail resources 630, reference resources 640, and/or other appropriate resources.

One of ordinary skill in the art will recognize that processes 700-1100 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

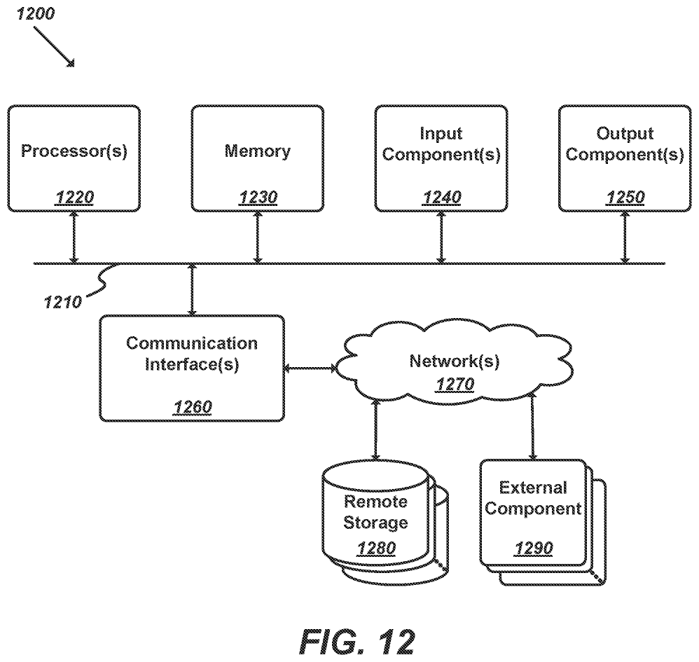

FIG. 12 illustrates a schematic block diagram of an exemplary device (or system or devices) 1200 used to implement some embodiments. For example, the systems, devices, components, and/or operations described above in reference to FIG. 1, FIG. 2, FIG. 3, FIG. 4, FIG. 5, and FIG. 6 may be at least partially implemented using device 1200. As another example, the processes described in reference to FIG. 7, FIG. 8, FIG. 9, FIG. 10, and FIG. 11 may be at least partially implemented using device 1200.

Device 1200 may be implemented using various appropriate elements and/or sub-devices. For instance, device 1200 may be implemented using one or more personal computers (PCs), servers, mobile devices (e.g., smartphones), tablet devices, wearable devices, and/or any other appropriate devices. The various devices may work alone (e.g., device 1200 may be implemented as a single smartphone) or in conjunction (e.g., some components of the device 1200 may be provided by a mobile device while other components are provided by a server).

As shown, device 1200 may include at least one communication bus 1210, one or more processors 1220, memory 1230, input components 1240, output components 1250, and one or more communication interfaces 1260.

Bus 1210 may include various communication pathways that allow communication among the components of device 1200. Processor 1220 may include a processor, microprocessor, microcontroller, digital signal processor, logic circuitry, and/or other appropriate processing components that may be able to interpret and execute instructions and/or otherwise manipulate data. Memory 1230 may include dynamic and/or non-volatile memory structures and/or devices that may store data and/or instructions for use by other components of device 1200. Such a memory device 1230 may include space within a single physical memory device or spread across multiple physical memory devices.

Input components 1240 may include elements that allow a user to communicate information to the computer system and/or manipulate various operations of the system. The input components may include keyboards, cursor control devices, audio input devices and/or video input devices, touchscreens, motion sensors, etc. Output components 1250 may include displays, touchscreens, audio elements such as speakers, indicators such as light-emitting diodes (LEDs), printers, haptic or other sensory elements, etc. Some or all of the input and/or output components may be wirelessly or optically connected to the device 1200.

Device 1200 may include one or more communication interfaces 1260 that are able to connect to one or more networks 1270 or other communication pathways. For example, device 1200 may be coupled to a web server on the Internet such that a web browser executing on device 1200 may interact with the web server as a user interacts with an interface that operates in the web browser. Device 1200 may be able to access one or more remote storages 1280 and one or more external components 1290 through the communication interface 1260 and network 1270. The communication interface(s) 1260 may include one or more application programming interfaces (APIs) that may allow the device 1200 to access remote systems and/or storages and also may allow remote systems and/or storages to access device 1200 (or elements thereof).

It should be recognized by one of ordinary skill in the art that any or all of the components of computer system 1200 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1200 may perform various operations in response to processor 1220 executing software instructions stored in a computer-readable medium, such as memory 1230. Such operations may include manipulations of the output components 1250 (e.g., display of information, haptic feedback, audio outputs, etc.), communication interface 1260 (e.g., establishing a communication channel with another device or component, sending and/or receiving sets of messages, etc.), and/or other components of device 1200.

The software instructions may be read into memory 1230 from another computer-readable medium or from another device. The software instructions stored in memory 1230 may cause processor 1220 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

We claim:

1. A device, comprising:
one or more processors configured to:
generate an appointment reminder and provide the appointment reminder to a user;
receive a set of user selections associated with the appointment reminder;
generate a visit plan based on the set of user selections; and
provide the visit plan to the user and to a veterinary practice.

2. The device of claim 1, wherein generating the appointment reminder comprises:
receiving pet and owner information from the veterinary practice;
applying a set of suggestion models to the received pet and owner information;
generating a set of suggestions for services or products based on the application of the set of suggestion models; and
generating a user interface (UI) including the set of suggestions.

3. The device of claim 2, wherein each suggestion in the set of suggestions comprises:
a reference to at least one service or product; and
a price for the at least one service or product.

4. The device of claim 3, wherein generating the visit plan comprises:
generating a listing of products and services based on the set of user selections; and
receiving a price for each product and service in the listing of products and services.

5. The device of claim 1, the one or more processors further configured to:
receive feedback from the veterinary practice during a visit associated with the visit plan; and
update the UI based on the received feedback.

6. The device of claim 5, the one or more processors further configured to:
receive user feedback via the UI; and
update the visit plan based on the received user feedback.

7. The device of claim 6, the one or more processors further configured to generate an invoice based on the updated visit plan.

8. A non-transitory computer-readable medium, storing a plurality of processor-executable instructions to:
generate an appointment reminder and provide the appointment reminder to a user;
receive a set of user selections associated with the appointment reminder;
generate a visit plan based on the set of user selections; and
provide the visit plan to the user and to a veterinary practice.

9. The non-transitory computer-readable medium of claim 8, wherein generating the appointment reminder comprises:
receiving pet and owner information from the veterinary practice;
applying a set of suggestion models to the received pet and owner information;
generating a set of suggestions for services or products based on the application of the set of suggestion models; and
generating a user interface (UI) including the set of suggestions.

10. The non-transitory computer-readable medium of claim 9, wherein each suggestion in the set of suggestions comprises:
a reference to at least one service or product; and
a price for the at least one service or product.

11. The non-transitory computer-readable medium of claim 10, wherein generating the visit plan comprises:
generating a listing of products and services based on the set of user selections; and
receiving a price for each product and service in the listing of products and services.

12. The non-transitory computer-readable medium of claim 8, the plurality of processor-executable instructions further to:
receive feedback from the veterinary practice during a visit associated with the visit plan; and
update the UI based on the received feedback.

13. The non-transitory computer-readable medium of claim 12, the plurality of processor-executable instructions further to:
receive user feedback via the UI; and
update the visit plan based on the received user feedback.

14. The non-transitory computer-readable medium of claim 13, the plurality of processor-executable instructions further to generate an invoice based on the updated visit plan.

15. A method comprising:
generating an appointment reminder and provide the appointment reminder to a user;
receiving a set of user selections associated with the appointment reminder;
generating a visit plan based on the set of user selections; and
providing the visit plan to the user and to a veterinary practice.

16. The method of claim 15, wherein generating the appointment reminder comprises:
receiving pet and owner information from the veterinary practice;
applying a set of suggestion models to the received pet and owner information;
generating a set of suggestions for services or products based on the application of the set of suggestion models; and
generating a user interface (UI) including the set of suggestions.

17. The method of claim 16, wherein each suggestion in the set of suggestions comprises:
a reference to at least one service or product; and
a price for the at least one service or product.

18. The method of claim 17, wherein generating the visit plan comprises:
generating a listing of products and services based on the set of user selections; and
receiving a price for each product and service in the listing of products and services.

19. The method of claim 15 further comprising:
receiving feedback from the veterinary practice during a visit associated with the visit plan; and
updating the UI based on the received feedback.

20. The method of claim 19 further comprising:
receiving user feedback via the UI;
updating the visit plan based on the received user feedback; and
generating an invoice based on the updated visit plan.
